(19) United States
(12) Patent Application Publication
(10) Pub. No.: US 2009/0112670 A1
(43) Pub. Date: Apr. 30, 2009

(54) HUMAN RESOURCES METHOD FOR EMPLOYEE TERMINATION PROCEDURES

(76) Inventors: Steven C. Black, Mendon, UT (US); John P. Boggs, Half Moon Bay, CA (US)

Correspondence Address: Workman Nydegger;1000 Eagle Gate Tower, 60 East South Temple, Salt Lake City, UT, 84111, US

(21) Appl. No.: 12/346,288

(22) Filed: Dec. 30, 2008

Related U.S. Application Data
(63) Continuation-in-part of application No. 10/848,809, filed on May 19, 2004.
(60) Provisional application No. 60/474,044, filed on May 29, 2003.
(60) Provisional application No. 61/018,632, filed on Jan. 2, 2008.

(51) Int. Cl. G06Q 10/00

(52) U.S. Cl. 705/7

(57) ABSTRACT

In one example, a human resources method for employee termination procedures includes various acts. First, a server system receives, from a client system, an indication that an employee termination is voluntary. Next, the server system automatically generates a checklist listing a set of forms that correspond to the voluntary employee termination. Then, the server system automatically generates the set of forms. Finally, the server system sends, to the client system, the checklist and the set of forms.

### CROSS-REFERENCE TO A RELATED APPLICATION

The present application is a continuation in part of U.S. patent application Ser. No. 10/848,809, filed May 19, 2004, and entitled “AUTOMATED COMPLIANCE FOR HUMAN RESOURCE MANAGEMENT,” which claims priority from U.S. Provisional Patent Application Ser. No. 60/474,044, filed May 29, 2003, entitled “WEB BASED SYSTEMS AND METHODS FOR HUMAN RESOURCES COMPLIANCE MANAGEMENT.” The present application also claims priority from U.S. Provisional Patent Application Ser. No. 61/018,632, filed Jan. 2, 2008, and entitled “HUMAN RESOURCES METHOD FOR EMPLOYEE TERMINATION PROCEDURES.” Each of the foregoing applications is incorporated herein by reference in its entirety.

### BACKGROUND

Human resources managers and other personnel are presently faced with an increasingly complex, and frequently changing, web of human resources requirements (including rules, statutes, regulations and other guidelines) with which they must either comply, or else face potentially costly and time-consuming legal action. The ability of an employer, and its personnel, to fully and timely comply with the various human resources requirements that apply to human resources management is significantly affected by the complexity of those human resources requirements, as well as by the fact that legislation constantly changes the human resources requirements with which employers must comply. Employee turnover, retirement, training and other dynamic events also contribute to the number of processes that must be continually addressed by the human resources personnel.

In businesses characterized by high turnover, the human resources workload can be quite significant. In particular, a substantial amount of documentation is required to manage and track the transition of employees through the application, training, and termination processes. One difficulty with managing human resources concerns the production and distribution of employee forms, particularly when it is necessary to ensure that forms have been updated according to the latest human resources requirements.

Changes in human resources requirements can create a further burden on human resources departments, even beyond the initial burden to establish and maintain awareness of the changes in the human resources requirements. In particular, changes in human resources requirements can also result in financial expenditures by an employer when that employer implements the training necessary for human resources personnel to learn the new human resources requirements. The acquisition of new forms by the employer, as well as updating the existing processes and procedures, may impose further expenses on the employer.

In these cases, as well as in cases where there is little change in employee turnover or the state of applicable human resources requirements, ensuring compliance with human resources requirements may be difficult to manage because ensuring compliance is often relegated to a relatively low position in terms of the priorities of the employer, either intentionally or accidentally. As explained above however, the failure of an employer to comply with the applicable human resources requirements can expose the employer to significant legal liability.

Nevertheless, despite the importance of compliance with human resources requirements, as well as the potentially significant costs and risks associated with non-compliance, many employers lack a method or process to systematically identify and address human resources issues implicated by the hiring, disciplining, separation, termination, reporting, and other processes of the employer.

Yet another problem that plagues human resources departments is the difficulty of ensuring that employees are appropriately disciplined and/or terminated when the need arises. A variety of factors influence what steps should be taken and what documentation should be completed in order to appropriately discipline and/or terminate an employee. These factors, along with frequently evolving human resources requirements, can make appropriate discipline and/or termination of an employee very burdensome for human resources personnel.

### SUMMARY OF SOME EXAMPLE EMBODIMENTS

In general, example embodiments of the invention relate to business methods and systems for managing human resources and, more particularly, for automating employee termination procedures.

In one example embodiment, a human resources method for employee termination procedures includes various acts. First, a server system receives, from a client system, an indication that an employee termination is voluntary. Next, the server system automatically generates a checklist listing a set of forms that correspond to the voluntary employee termination. Then, the server system automatically generates the set of forms. Finally, the server system sends, to the client system, the checklist and the set of forms.

In another example embodiment, a human resources method for employee termination procedures includes various acts. First, a server system receives, from a client system, an indication that an employee is subject to a termination and an indication as to whether or not the employee is eligible for rehire. Next, the server system automatically generates a checklist listing a set of forms that correspond to the employee termination. Then, the server system automatically generates the set of forms. Finally, the server system sends, to the client system, the checklist and the set of forms.

In yet another example embodiment, a human resources method for employee termination procedures includes various acts. First, a server system receives, from a client system, an indication that a planned employee termination is disciplinary. Next, the server system sends, to the client system, a list of one or more disciplinary action reports that have been previously generated regarding the employee. Then, the server system sends, to the client system, one or more requirements that were previously automatically generated in response to a previous generation of a disciplinary action report for termination regarding the employee. Next, the server system automatically generates a checklist listing a set of forms that correspond to the disciplinary employee termination. Then, the server system automatically generates the set of forms. Finally, the server system sends, to the client system, the checklist and the set of forms.

In still another example embodiment, a human resources method for employee termination procedures includes various acts. First, a client system sends, to a server system, an indication that an employee is subject to a termination. Then, the client system receives, from the server system, a set of forms that correspond to the employee termination and a checklist listing the set of forms.

### BRIEF DESCRIPTION OF THE DRAWINGS

To further clarify certain aspects of example embodiments of the invention, a more particular description of the invention will be rendered by reference to example embodiments thereof which are disclosed in the appended drawings. It is appreciated that these drawings depict only example embodiments of the invention and are therefore not to be considered limiting of its scope nor are they necessarily drawn to scale. Example aspects of example embodiments of the invention will be described and explained with additional specificity and detail through the use of the accompanying drawings in which:

FIG. 1 discloses an embodiment of a network environment in which client systems can communicate with a server system that may be configured to leverage third party resources;

FIG. 2 is a flowchart of an example method for managing human resources compliance involving employee forms that are generated and updated for an employer and that are presented to the employer in an appropriate order;

FIG. 3 is a flowchart of a first example method for managing human resources compliance involving the voluntary termination of an employee;

FIG. 4 is a flowchart of a second example method for managing human resources compliance involving the involuntary termination of an employee;

FIG. 5 is a flowchart of a third example method for managing human resources compliance involving the disciplinary termination of an employee;

FIGS. 6-12 are directed to various displays such as might be presented to a user by way of an example Termination Module graphical user interface;

FIG. 13 is an example Termination Document Checklist; and

FIGS. 14 and 15 are directed to additional displays such as might be presented to a user by way of an example Termination Module graphical user interface.

### DETAILED DESCRIPTION OF SOME EXAMPLE EMBODIMENTS

Example embodiments of the invention relate to methods and systems for managing human resources and, more particularly, for automating the compliance of human resources termination processes with dynamic and static legal criteria.

Embodiments of the invention may take the form of various software applications that facilitate the management of human resources and help to drive, and ensure, compliance with human resources requirements. As used herein, the term “human resources requirements” refers to statutes, rules, regulations, and other guidelines of governments (e.g., federal, state, and/or local governments) and governmental agencies, as well as employer specific policies and practices in areas such as, but not limited to, hiring practices, employee training, employee transfers, employee separation, employee discipline, and employee termination. Embodiments of the invention can be employed in any type of industry or business. Though embodiments of the invention may be particularly advantageous in relatively high-turnover businesses, even relatively low-turnover businesses can benefit from embodiments of the invention.

Embodiments of the invention can include special purpose and general-purpose computing devices having various computer hardware and software. Embodiments within the scope of the present invention can also include computer-readable media for carrying or having computer-executable instructions or data structures stored thereon. Computer-executable instructions comprise, for example, instructions and data which cause a general purpose computer, special purpose computer, or special purpose processing device to perform a certain function or group of functions.

Computer-readable media, on the other hand, can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means or modules in the form of computer-executable instructions or data structures and which can be accessed by a general purpose or special purpose computer.

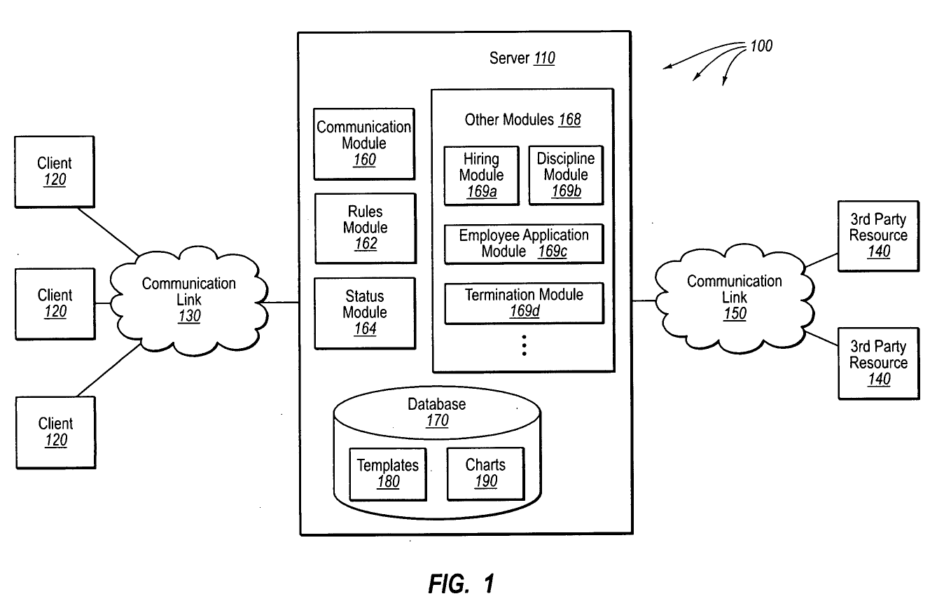

When information is transferred or provided over a network connection (either hardwired, optical, wireless, or a combination of hardwired, optical and/or wireless including IR and RF connections) to a computer, the computer also views the network connection as a computer-readable medium. Combinations of the above should also be included within the scope of computer-readable media. Accordingly, communication links 130 and 150, described below in reference to FIG. 1 can also be considered computer-readable media.

### 1. Example Network Environment

Attention will now be directed to FIG. 1, which illustrates a network environment 100 in which example embodiments of the invention can be practiced. As shown, a server system 110 is connected with one or more client systems 120 through a communication link 130. The communication link 130 can be any network connection. According to one embodiment, the communication link includes a LAN, a WAN, and/or the Internet, such that the one or more client systems 120 can communicate with the server system 110 through a LAN, a WAN, and/or the Internet.

The server system 10 is also shown to be connected with one or more third party resources 140 through a suitable communication link or links 150. In some example embodiments, the communication links 130 and 150 can be the same communication link. The third party resources 140 can include any combination of computing devices, software, and network systems. According to one embodiment, the third party resources 140 can include repositories of human resources requirements, as well as agencies, such as investigative agencies that can be used to perform and/or report the results of a background check or screening process. Third party resources 140 can also comprise such things as labor insurance, health insurance and safety program providers.

In other embodiments, the client system(s) 120 are also configured to communicate directly with the third party resource(s) 140 through a suitable communication link (not shown). In such embodiments, the server system 110 can still provide useful functionality by facilitating compliance with existing human resources requirements and for instructing the client system(s) 120 how and when it is appropriate to contact the third party resource(s) 140.

As shown, the server system 110 includes various modules (160, 162, 164, and 168) and a database 170 that can be used to help manage human resources compliance at the client systems 120.

Each of the illustrated modules (160, 162, 164, 168), although described as corresponding to one or more particular subject areas, also includes the ability to communicate with, and operate in connection with, one or more of the other modules. For example, data or results output from one module may comprise input to one or more other modules. Moreover, alternative or additional functional modules 168 can be incorporated into the system as necessary to suit changing needs and requirements. In addition, the functionalities disclosed herein may be allocated in various ways among the functional modules (160, 162, 164, and 168) and/or between the server system 10, one or more client systems 120, and one or more third party resources 140. Accordingly, the allocation of functionalities disclosed herein is exemplary only and is not intended to limit the scope of the invention in any way.

The first illustrated module, the communication module 160, is configured with suitable computer-executable instructions for enabling the server system 10 to communicate with the client systems 120 and the third party resources 140. Accordingly, the communication module 160 can include hardwired, wireless, and/or optical communications components to enable communication over hardwired networks, as well as optical and/or wireless networks. The communication module 160 can also include any other components that may be necessary to enable communication between the server system 110 and the client systems 120 and third party resources 140, including, but not limited to, OCR (optical character recognition), voice recognition and translation components.

The communication module 160 also includes functionality for authenticating and authorizing the client system 120 access to information stored by the server system 110, as well as for encrypting data transmissions. According to one embodiment, the communication module 160 also includes functionality for enabling and authenticating digital signatures of employers and employees, which may be required, for example, to verify requested consent and approval, and/or to execute a legal document.

The rules module 162 includes computer-executable instructions for managing and tracking the human resources requirements that are to be complied with by users associated with the client systems 120. According to one embodiment, the rules module 162 is configured to query one or more third party resources 140 to determine the current human resources requirements regarding a particular process. The rules module 162 can also include corresponding calendaring functionality for determining a suitable time to initiate a query to one or more third party resources 140 for any updates in the human resources requirements, such as, for example, based on a predetermined period of time or occurrence or non-occurrence of an event.

In other embodiments, the rules module 162 is configured to passively receive input regarding human resources requirements with which user associated with the client systems 120 are to comply. The rules module 162 tracks the current state of the human resources requirements in a chart 190, table and/or other data structures within the database 170. The rules module 162 may be configured to actively pull current human resources requirements from one or more third party resources 140 and/or one or more of the third party resources 140 may be configured to actively push current human resources requirements to the rules module 162. The client systems 120 can pull, and/or have pushed to them, the human resources requirements from the rules module 162. More generally, any of the modules or systems of system 100 of FIG. 1 can actively pull information, and/or have information actively pushed to them, from another system/module.

Changes in human resources requirements that are received by the rules module 162 can then be incorporated into the templates 180 and into employer human resources processes that are managed by the server system 110. In at least some embodiments, the templates 180 are pre-existing forms that include standard text as well as blank fields into which employer-specific custom text can be inserted. It will be appreciated that while some changes in human resources requirements can be implemented automatically into templates 180 and/or processes by the server system, other changes may require a system administrator to manually implement the change.

The rules module 162 also includes the functionality to track and report the progress of one or more client systems 120 through a particular human resources process such as, but not limited to, hiring an employee, training an employee, or compensating an employee, terminating an employee, and to determine whether the client system 120 is complying with, or overriding, a prescribed sequence for advancing through each process. For example, in some example embodiments the client system is allowed some leeway to override a prescribed sequence or portion of a prescribed sequence, while in other example embodiments, the client system is forced to comply with a prescribed sequence.

The rules module 162 can also function to track, and comply with, human resources requirements related to privacy so as to ensure that the information that is received by the server system 110 from the client systems 120 is not shared, used or handled by the server system 110 in violation of the privacy requirements related to human resources information.

The status module 164 is configured to monitor, track, and report on the status of employer applicants, employees, and other employer objects that are involved in a human resources process. The status module 164 is also configured to monitor, track, and report on the progress of employer applicants, employees, and other employer objects through a human resources process. The status module 164 also includes the functionality to query for information regarding a particular employer object. For example, the status module 164 might utilize the communication module 160 to initiate a background check by a third party resource 140 of a prospective employee, or of a current employee. The status module 164 might also utilize the communication module 160 to determine whether an applicant has submitted a requested piece of information. The status module 164 might then generate a report that is sent to one of the client systems 120 with the requested piece of information. Alternatively, or additionally, the status module 164 may generate a report that is stored on the server system 110 or sent to one of the third party resources 140.

The status module 164 can also obtain relevant status information from various sources, including the templates 180 that are submitted by the client system 120 and/or that are provided by the server system 110 to the client system 120. The status data of employers can be tracked within the charts 190 and/or other data structures of the database 170. The term “status data,” should not be construed narrowly. Instead, “status data” should be broadly construed to include any information corresponding to the employer or other parties (e.g. applicants, employees, owners, officers, contractors, etc.), such as, but not limited to, personalized information (e.g., name, address, birthday, or demographics such as race, gender, etc.), as well as professional information (e.g., experience, title, position, compensation, employment history, etc.). Status data can also be directed to a particular human resources process, such as application status (e.g., complete/incomplete), interview status (e.g., passed/failed), screening status (e.g., passed/failed), offer status (e.g., conditional/accepted/rejected), and so forth.

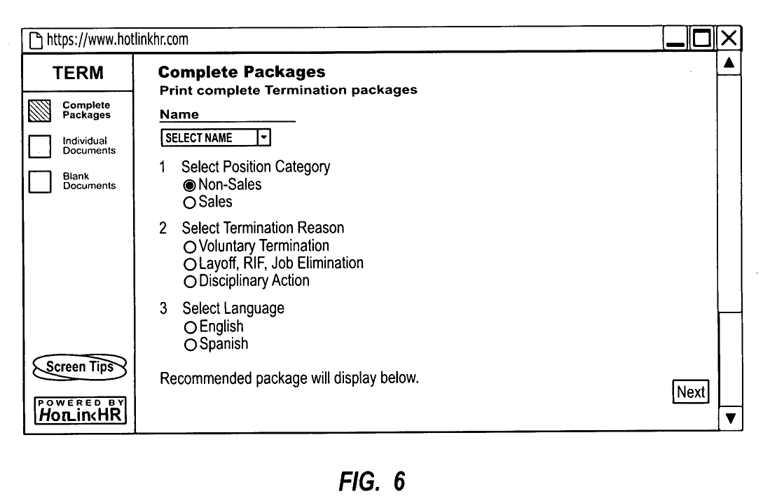

Other modules 168, some of which are described in more detail below, such as the hiring module 169a, the discipline module 169b, the employee application module 169c, and the termination module 169d are configured with computer-executable instructions for facilitating compliance with various human resources requirements, as disclosed herein. Additional aspects of example displays of the termination module 169d are disclosed below in connection with FIGS. 6-12, 14, and 15.

The database 170 is currently shown to be incorporated within the server system 110. Nevertheless, it will be appreciated that the database 170 can include remote data storage as well as local data storage. Likewise, it will also be appreciated that the database 170 can include any combination or quantity of computer-readable media, including, but not limited to RAM, ROM, EEPROM, CD-ROM, other optical disk storage, magnetic disk storage and magnetic storage devices. The database 170 may include a variety of different data structures including, but not limited to lists, associative arrays, and tree data structures. The database 170 may further comprise software, dedicated hardware, and/or a combination of software and dedicated hardware. The database 170 may further be configured as a primary database or a backup database on a primary or backup server.

### 2. Methods for Managing Human Resources Compliance

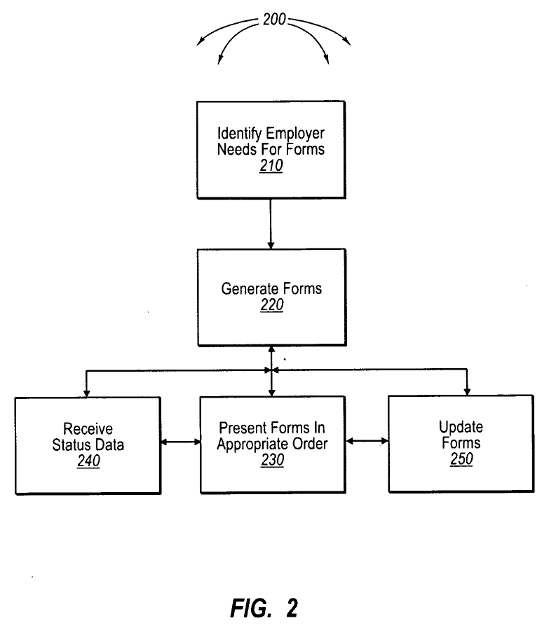

Attention will now be directed to FIG. 2, which illustrates a flowchart 200 of one embodiment of a method for managing human resources compliance. As shown, the method begins with the act of a server system identifying employer needs for forms (act 210). The act 210 may at least partially rely on previously gathered information about the employer such as, but not limited to, the employer's industry, number of employees, and/or type of employees. The term “form” should be broadly construed to include any form, template, report, document, manual, or other material that can be used to implement part or all of a human resources process. Non-limiting examples of forms include applications, authorizations, requests, disclosures, instruction materials, reports, and training materials.

The act of identifying an employer need for a form (act 210) can be accomplished by the server system directly, by receiving an explicit request from an employer, or indirectly by the server system, by determining that an employer needs a form based on an evaluation of, for example, employer characteristics and based on human resources requirements that require a form for implementation of a particular process by the employer and/or by the employee. The identification of an employer need for a form (act 210) can also include identifying a change in human resources requirements or in the employer status that requires a form to be updated or produced for that employer.

The appropriate forms are then generated by the server system for the employer (act 220). According to one embodiment, the generated forms are customized for each employer according to the available status information that is currently known about the employer and according to the existing human resources requirements. For example, if different forms are required for different sized employers, different employer types, and/or different employee types (such as exempt, non-exempt, part-time, full-time, permanent, or seasonal), the server system generates the appropriate form for that employer.

Likewise, the generation of forms (act 220) can also include the auto-completing, or auto-population, of the forms with data that is presently known by the server system or that is automatically obtained by the server system in response to a query. For example, if a form has fields that need to be completed by the employer or employee, that information can be automatically input by the server system into the fields on the form when the requested data is already known. In addition, if a form has fields that should not be changed, those fields can be locked by the server system so that they are not inadvertently or purposely modified by the employer or employee.

Thereafter, the forms can be presented by the server system to the employer for their intended purpose, and in compliance with the human resources requirements governing the employer process (act 230). The automatic presentation of forms enables the server system to force compliance by the employer with the human resources requirements corresponding to the forms. Compliant forms are automatically presented to the employer by the server system in the appropriate format and at the appropriate time, without request by the employer. For example, if an employer needs to submit a form to a government agency, that form can be produced and presented to the employer for completion. This presentation can be accomplished by displaying the form on a client system display and/or by automatically printing the form on a client system printer. Of course, printing the form may not be necessary in some circumstances, such as where a form is filed electronically with a government agency, for example. Alternatively, if enough information is known about the employer to complete the form, the form can be auto-completed by the server system and submitted to the employer for final approval. Thereafter, the employer can submit the form electronically, or otherwise, to the appropriate agency. The employer may also authorize the server system to submit the form, in which case the employer can digitally sign the document, as suggested above. The employer may also store completed or partially completed forms, such as on one of the client systems 120 or in the database 170 of the server system 110 (see FIG. 1).

One benefit provided by some example embodiments of the present invention is that such example embodiments not only enable the creation of forms and information for an employer that are compliant with the existing human resources requirements, but such example embodiments also determine the appropriate order as well as timing in which the forms and information should be presented, so as to further facilitate compliance with human resources requirements. For example, if an employer cannot legally terminate an employee as a disciplinary action until the employer first warns/reprimands the employee and generates supporting documentation, such as one or more disciplinary action reports, then the server system will determine this and will dynamically allow the employer to terminate an employee only after the employer has warned/reprimanded the employee and has generated supporting documentation.

Many of the employer forms generated by the server system will request status data about the employer or other parties, such as applicants or employees. In one embodiment, status data is received (act 240) at the server system in direct response to a query for information by the server system. In some example embodiments, when an employer completes and submits a form to the server system, the server system automatically submits a query to a database or other system and, in response, receives status data. For example, when an employer begins the termination process for an employee, and submits a termination request and related information to the server system, the server system receives the termination request and related information (act 240) and stores the information for future use. Status data can also be obtained automatically when the server system, for example, queries a database or system associated with the employer. This status data may be obtained by the server system without requiring the employer to expressly or manually fill out a form or respond to a specific request. Status data about an employer or employer party can alternatively be obtained by the server system indirectly through a remote third party resource, such as an investigative agency, credit bureau, and so forth.

Whenever status data is received (act 240) and/or whenever the human resources requirements have changed, there is the possibility that the forms produced for the employer either need to be updated (act 250) and/or reordered and presented in an appropriate order (act 230) to accommodate the change(s). Updating forms can include adding new forms, modifying forms, or deleting forms.

Accordingly, in one embodiment of the invention, the forms are dynamically updated by the server system to accommodate changes in human resources requirements. For example, if a change in human resources requirements prohibits an employer from requesting certain information, the rules module 162 will automatically determine whether the change in human resources requirements created a conflict or inconsistency with any existing forms. If there is a conflict between a change in human resources requirements and an existing form, the form will automatically be changed to accommodate the new human resources requirements. For example, in the present case, the prohibited request for information would be stricken from any existing forms so that the employer would only be presented with forms that are compliant with the current human resources requirements. Where a form that has been partially completed requires a change to accommodate new human resources requirements, the partially completed form may be updated and the partially complete data retained to the extent that the data remains relevant, or the partially completed form may be deleted and the employer may be notified that the partially completed form has been changed and must be redone.

According to some embodiments, the order in which forms are presented to the employer will also change dynamically to accommodate changes in the human resources requirements and/or status data received from the employer. For example, if a change in human resources requirements includes a provision requiring an employee to be given the opportunity to be warned/reprimanded with supporting documentation before being terminated for disciplinary reasons, the server system would automatically generate a notification to the employer that supporting documentation must be generated before finalizing the termination. The server system may further generate a corresponding data structure for tracking the employer's response to the notification.

In some embodiments, notices regarding changes in human resources requirements are also generated by the server system, via email or banners for example, to advise the employer of the recent changes and to instruct the employer of the steps that must be taken to be compliant with the new human resources requirements. This may require the employer to repeat certain steps that have already been performed, such as filling out forms, after the forms have been updated. This functionality can be particularly useful when considering that a change in human resources requirements can occur ‘mid-stream,’ after a human resources process has already begun, but prior to its completion.

Supporting documentation could also be customized for each employee, depending on the needs of the employer, and could be presented to the employer in an electronic format by way of the Internet or other network, thereby eliminating the need for the employer to expend the time and cost associated with creating supporting documentation in a paper or handwritten format and ensuring that the documentation is generated in a legally compliant manner.

It will be appreciated that in this manner, it is possible to reduce or eliminate the need for employer human resources departments to individually monitor, track, and maintain certain processes. Instead, the employer can rely on the server system to effectively implement and monitor disclosure and certain other human resources processes, and to notify the employer about various employer actions that need to be taken. The server system also can handle recordkeeping, or can assist the employer in doing so.

In each of the forgoing and following examples, a user interface can also be provided to facilitate access to various forms and materials. Access to different data through the user interface can also be controlled according to different authorization levels to accommodate virtually any need and preference. The user interface can be presented to the employer in various ways. For example, the user interface can be provided to the employer through a webpage browser-based application as well as through direct access.

According to one embodiment, the user interface generally provides access to forms corresponding to a variety of human resources processes. Access to the forms is controlled at least in part by the human resources requirements governing the human resources process, as well as by the needs of the employer. For example, the user interface can restrict an employer from accessing (e.g. the user interface can provide ‘read only’ access) a particular form until employer status data (e.g., form data) is received and/or until human resources requirements for submitting the form have been satisfied. In this way, the server system drives and controls human resources processes to ensure that these processes are compliant with human resources requirements.

By way of illustration, and not limitation, the user interface can provide checklists that need to be manually checked off by a user before the user is allowed to advance to a different screen of the interface or prior to receiving a desired form. In such circumstances, the checklists may require input (e.g., employer status data) that indicates a particular task has been completed or that provides a requisite piece of information. If a user provides inconsistent and/or inaccurate information, the server system can flag problems to the user and redirect the user back to the appropriate screen of the interface to correct the inconsistency or inaccuracy.

Typically, the user interface presents the forms that are being requested by the employer, and at the time they are requested. However, as described above, the availability of the forms, as well as the sequence in which they are provided, may be contingent upon employer compliance with human resources requirements. Upon receiving employer input that is implicitly or explicitly requested by the form, the user interface then proceeds to obtain and display, in the appropriate order, additional forms to be used by the employer. For example, the additional forms may include training manuals, hiring packets, or other materials that are customized for a particular process. Customization can be performed, for example, by using the status data and input received from the employer.

The user interface may further present additional customized products/services for purchase by the employer. These additional customized products/services may be related to the status data and input received from the employer. For example, the user interface may present additional forms and related training manuals for purchase by the employer in response to a determination that the employer has grown to the point that government regulations applicable only to larger employers now apply to the employer.

In some embodiments, the user interface also includes a portion dedicated to highlighting recent changes in the human resources requirements that are used to govern the human resources processes. This way, the employer can be apprised of relevant changes in human resources requirements even though the employer may not be involved in the particular stage of a process that is currently being affected by the change in the human resources requirements. The interface can also be used as a medium for requesting and receiving information from the employer that can be used to generate or customize a form.

In some embodiments, the interface also provides portions dedicated to enabling the employer to generate and/or query tables, charts, reports, and spreadsheets indexing the status data corresponding to the employer, the human resources requirements corresponding to a human resources process, and status data corresponding to the applicants and employees of the employer.

In certain embodiments applicants and employees of the employer can also obtain limited access to the interface to undergo training, review the current human resources requirements of particular processes, access manuals and handbooks, fill out forms, request information, digitally sign documents, and to review their status information.

With general reference to one example application of the invention, the user interface can also be used to guide an auto dealer through various step-by-step processes that assure full and timely compliance of the auto dealer with human resources requirements in areas such as, but not limited to, applications for employment, hiring, new hires, employee training, employee discipline, employee separation, employee termination, retirement, and employer policies. The scope of the example embodiments disclosed herein are not limited to this application, but can be applied to any application that requires the functionality disclosed herein.

### 3. First Example Method of Managing Legally Compliant Termination

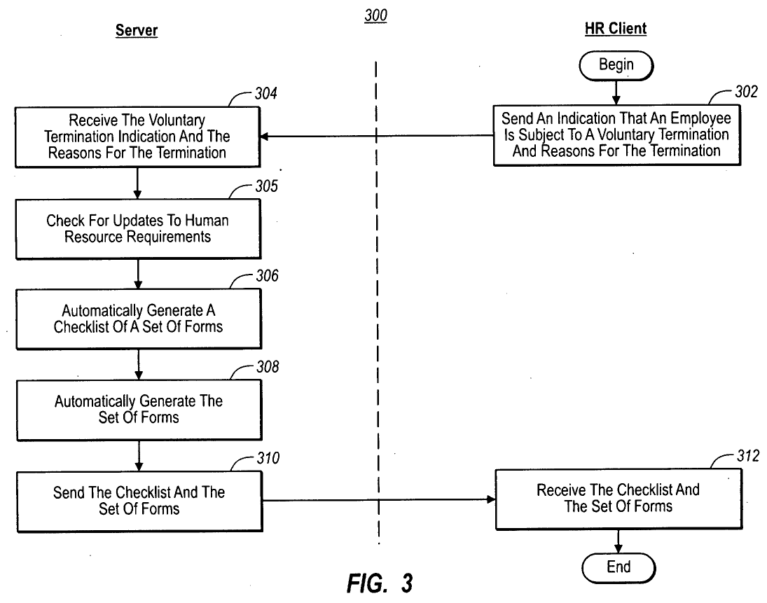

FIG. 3, which will now be described, illustrates a flowchart of a first example method 300 for an employer to use in terminating an employee. The first illustrated act of the example method 300 includes an HR client system sending an indication that an employee is subject to a voluntary termination, and providing reasons for the termination (act 302). Next, a server system receives the voluntary termination indication and the reasons for the termination (act 304). Next, the server system automatically checks for human resources requirements updates (act 305). Then, the server system automatically generates a checklist of a set of forms (act 306) based on the input received from the HR client system. Next, the server system automatically generates the set of forms (act 308) based on the input received from the HR client system. Then, the server system sends the checklist and the set of forms (act 310). Finally, the HR client system receives the checklist and the set of forms (act 312). Example embodiments of the example method 300 will also be described with reference to FIG. 1.

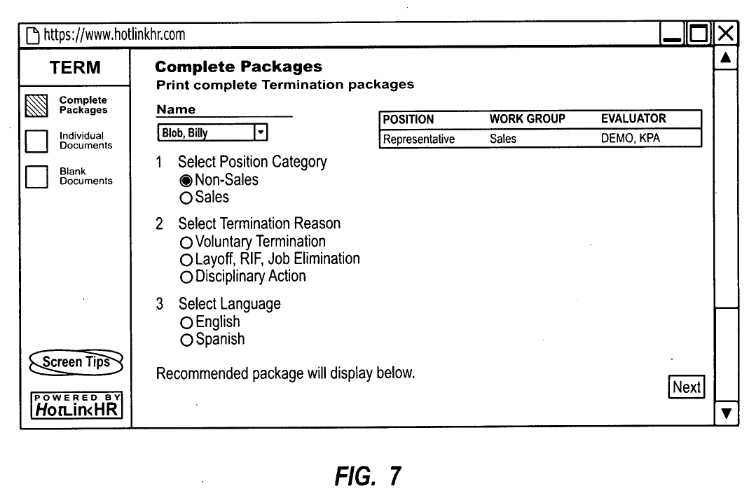

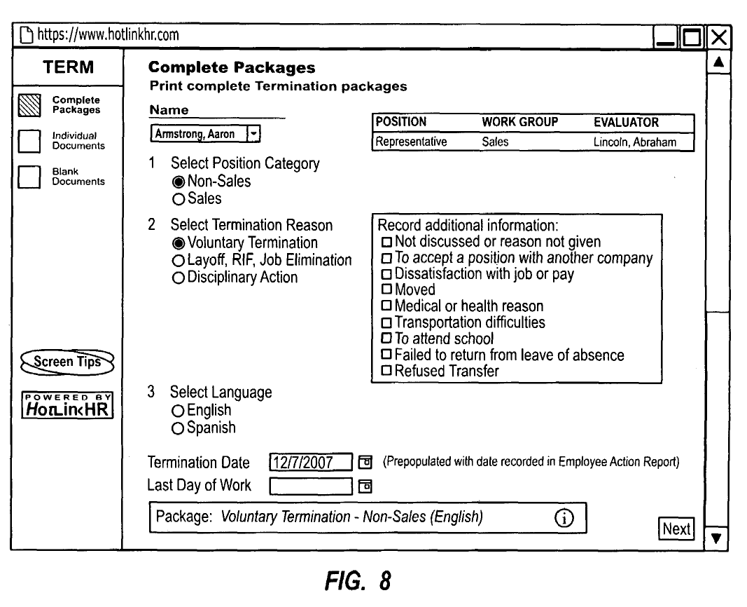

In an example embodiment of the method 300, at act 302, one of the client systems 120 can send, and at act 304 the termination module 169d of the server system 110 can receive, an indication that an employee is subject to a voluntary termination and reason(s) for the termination. As used herein, the term “voluntary termination” refers to an employee termination that is initiated by the employee. Acts 302 and 304 can be accomplished, for example, by first selecting the employee from the “Name” dropdown from the example display of FIG. 6. Once the employee is selected, as disclosed in the example display of FIG. 7, the position, work group, and evaluator of the employee may be automatically displayed. Whether the employee held a sales position or a non-sales position may be indicated by selecting the corresponding radio button on the example display of FIGS. 7. Thereafter, the “Voluntary Termination” radio button may be selected, as disclosed in the example display of FIG. 8. Then any appropriate checkbox(es) in the “Record additional information” box may be selected, as disclosed in the example display of FIG. 8. For example, as disclosed in FIG. 8, the reason(s) for the termination may include, but are not limited to, ‘Not discussed or reason not given’, ‘To accept a position with another company’, ‘Dissatisfaction with job or pay’, ‘Moved’, ‘Medical or health reason’, ‘Transportation difficulties’, ‘To attend school’, ‘Failed to return from leave of absence’, and/or ‘Refused Transfer’. Other reason(s) for a voluntary termination may include, for example, ‘Refusal to accept available work’, ‘Death’, ‘Retirement’, and/or other reasons. In some example embodiments, some of these example reasons for termination may also serve as the basis for a disciplinary termination, as discussed below.

Continuing with the example embodiment, at act 305, the rules module 162 automatically checks for human resources requirements updates. For example, the rules module 162 may automatically query one or more third party resources 140 to determine the current human resources requirements regarding a voluntary termination of an employee. Thereafter, the rules module 162 can also update any related form(s) with the current human resources requirements.

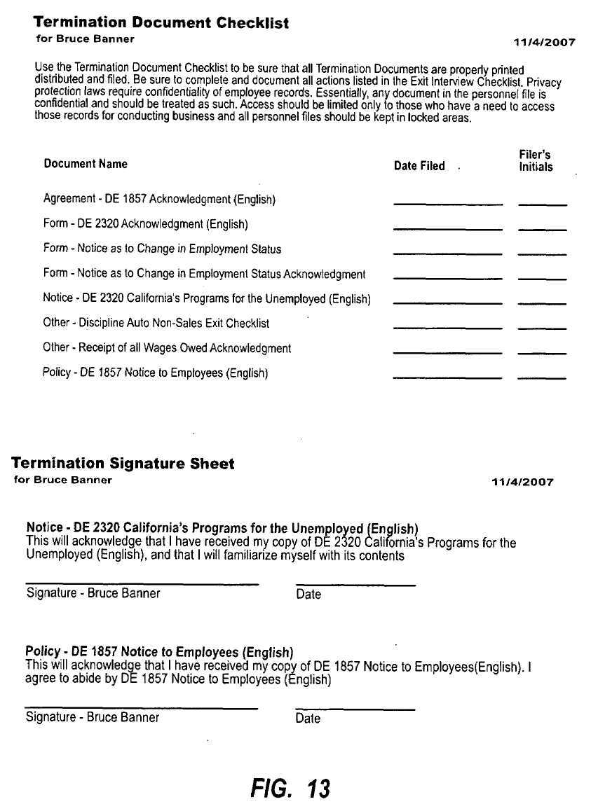

Continuing with the example embodiment, at act 306, the termination module 169d automatically generates a checklist of a set of form(s) corresponding to the employee termination. The number, content, and order of the forms listed on the checklist can be automatically adjusted according to a variety of criteria including, but not limited to, specific attributes of the employee being terminated, the industry in which the employee is employed, the government(s) having jurisdiction over the employee, and the type of position the employee holds or has previously held, such as sales vs. non-sales, or management vs. non-management. These criteria may be automatically retrieved from the database 170 or may be received from the client system 120 prior to the generation of the checklist. An example checklist is disclosed in FIG. 13.

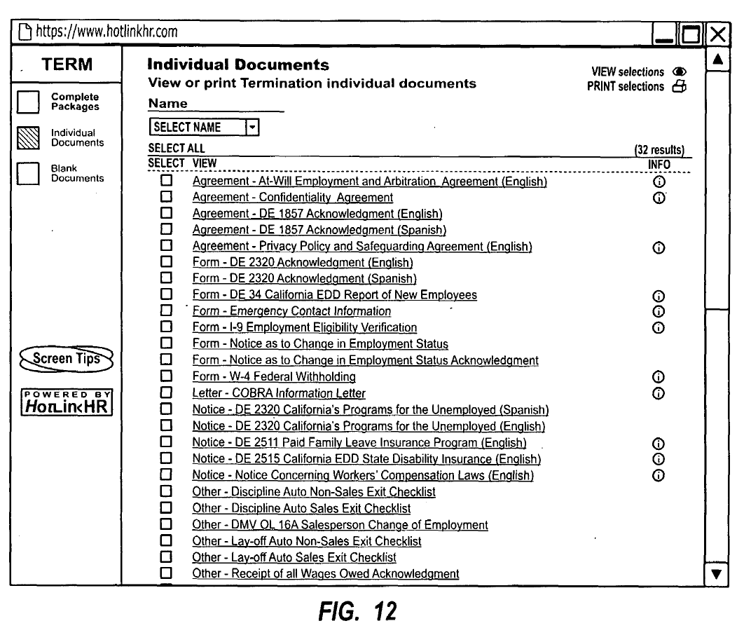

Continuing with the example embodiment, at act 308, the termination module 169d automatically generates the set of form(s) corresponding to the voluntary employee termination. Then, at act 310, the termination module 169d sends, and at act 312 the client system 120 receives, the checklist and the set of form(s) corresponding to the voluntary employee termination. An example set of forms is displayed on the example display of FIG. 12.

Thus, in the example embodiment of the example method 300 disclosed above, a checklist and a set of form(s) corresponding to a voluntary employee termination are generated and sent to a client system in order to facilitate a legally compliant voluntary termination of the employee.

### 4. Second Example Method of Managing Legally Compliant Termination

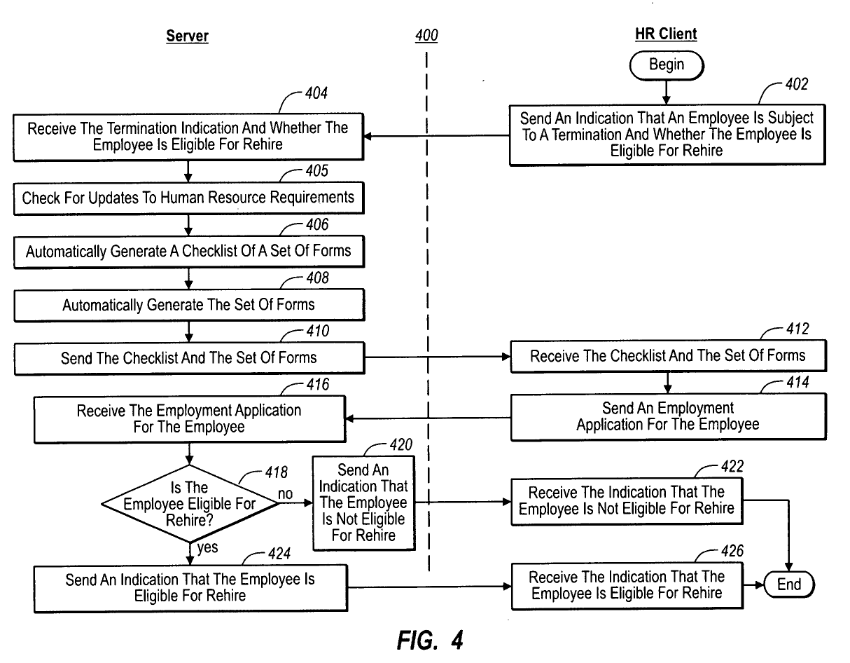

FIG. 4, which will now be described, illustrates a flowchart of a second example method 400 for an employer to use in terminating an employee. The first illustrated act of the example method 400 includes an HR client system sending an indication that an employee is subject to a termination and further indicating whether or not the employee is eligible for rehire (act 402). Next, a server system receives the termination indication and information indicating whether or not the employee is eligible for rehire (act 404). Next, the server system automatically checks for human resources requirements updates (act 405). Then, the server system automatically generates a checklist of a set of forms (act 406). Next, the server system automatically generates the set of forms (act 408). Then, the server system sends the checklist and the set of forms (act 410). Next, the HR client system receives the checklist and the set of forms (act 412). Later, upon reapplication of the employee for employment, for example, the HR client system sends a new employment application for the employee (act 414). Next, the server system receives the employment application for the employee (act 416). Then, the server system determines whether the employee is eligible for rehire (act 418). If the server system determines that the employee is not eligible for rehire, then the server system sends an indication that the employee is not eligible for rehire (act 420) and the HR client system receives the indication that the employee is not eligible for rehire (act 422). If, however, the server system determines that the employee is eligible for rehire, then the server system sends an indication that the employee is eligible for rehire (act 424) and the HR client system receives the indication that the employee is eligible for rehire (act 426). Example embodiments of the example method 400 will also be described with reference to FIG. 1.

In an example embodiment of the method 400, at act 402, one of the client systems 120 can send, and at act 404 the termination module 169d of the server system 110 can receive, an indication that an employee is subject to a termination and whether the employee is eligible for rehire. The indication received at act 404 may correspond to an involuntary termination. As used herein, the term “involuntary termination” refers to an employee termination that is initiated by the employer but is not based on the employee's poor performance. For example, an involuntary termination can include, but is not limited to, a layoff, a reduction in force, a job elimination, or other non-disciplinary non-voluntary termination. Where the type of termination is involuntary, the termination module 169d may further receive additional information from the client system 120 indicating whether or not the employee is eligible for rehire. For example, the termination may be temporary, such as where the employee is subject to recall, and thus the employee is eligible to be rehired. Conversely, the termination may be intended by the employer to be indefinite or permanent, in which case the employee is not eligible for rehire. The indication received at act 404 is not limited to involuntary disciplinary actions however. For example, such indication may correspond instead to a voluntary termination or a disciplinary termination, which types of termination are discussed elsewhere herein.

Where the termination module 169d receives additional information from the client system 120 indicating whether or not the employee is eligible for rehire, the termination module 169d may then communicate this information to other modules, such as the hiring module 169a. Then, in the event that the terminated employee is ever again considered for employment, the hiring module 169a can determine whether the terminated employee was eligible for rehire at the time that the terminated employee was terminated. For example, an “eligible for rehire” flag can be routinely set for each employee who is terminated. This “eligible” for rehire flag can then be routinely accessed if a terminated employee reapplies for employment with the employer.

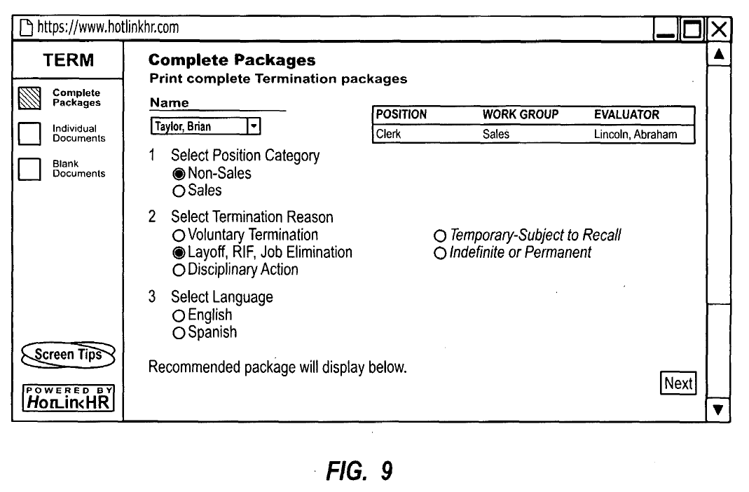

Acts 402 and 404 can be accomplished, for example, by first selecting the employee from the “Name” dropdown then selecting the “Layoff, RIF, Job Elimination” radio button, as disclosed in the example display of FIG. 9. Thereafter, either the “Temporary-Subject to Recall” radio button or the “Indefinite or Permanent” radio button may be selected, as disclosed in the example display of FIG. 9.

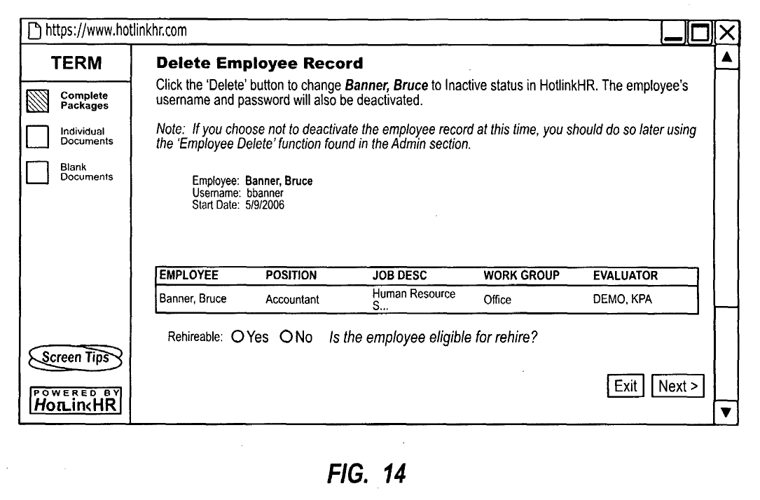

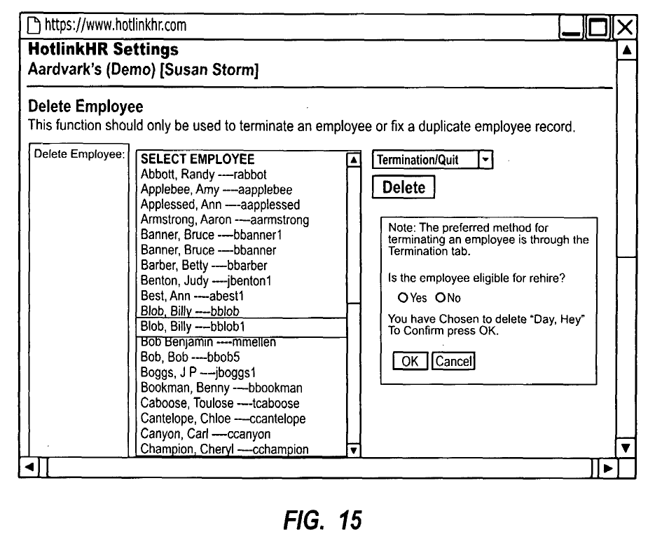

Alternatively, acts 402 and 404 can be accomplished, for example, by selecting either the “Yes” radio button or the “No” radio button next to the “Is the employee eligible for rehire?” label, as disclosed in the example display of FIG. 14. In yet another alternative, act 402 and 404 can be accomplished, for example, by selecting an employee from the “SELECT EMPLOYEE” control then selecting either the “Yes” radio button or the “No” radio button next to the “Is the employee eligible for rehire?” label, as disclosed in the example display of FIG. 15.

Continuing with the example embodiment, at act 405, the rules module 162 automatically checks for human resources requirements updates. For example, the rules module 162 may automatically query one or more third party resources 140 to determine the current human resources requirements regarding a termination of an employee. Thereafter, the rules module 162 can also update any related form(s) with the current human resources requirements.

Continuing with the example embodiment, at act 406, the termination module 169d automatically generates a checklist of a set of form(s) corresponding to the employee termination and, at act 408, the termination module 169d automatically generates the set of form(s) corresponding to the employee termination. The number, content, and order of the forms listed on the checklist can be automatically adjusted as described above in connection with the method 300. Then, at act 410, the termination module 169d sends, and at act 412 the client system 120 receives, the checklist and the set of form(s) corresponding to the employee termination.

Continuing with the example embodiment, at act 414, the client system 120 sends, and at act 416 the hiring module 169a receives, an employment application for the employee. Next, at act 418, the hiring module 169a determines whether the employee is eligible for rehire. For example, as discussed above, the information regarding whether an employee is eligible for rehire received by the termination module 169d at act 404 can be communicated to other modules, such as the hiring module 169a. Then, when the hiring module 169a receives an employment application for the terminated employee because the terminated employee is again being considered for employment, the hiring module 169a can determine at act 418 whether the employee was eligible for rehire at the time the employee was terminated. Act 418 may be accomplished, for example, by checking the “eligible for rehire” flag that was set at act 404, as discussed above.

Continuing with the example embodiment, if the hiring module 169a determines, at act 418, that the employee is not eligible for rehire, then, at act 420, the hiring module 169a sends, and at act 422 the client system 120 receives, an indication that the employee is not eligible for rehire. Conversely, if the hiring module 169a determines, at act 418, that the employee is eligible for rehire, then, at act 424, the hiring module 169a sends, and at act 426 the client system 120 receives, an indication that the employee is eligible for rehire. This information can then be used to alert the potential employer as to whether the applicant is eligible to be rehired. For example, an employment audit may be performed on each employment application received or generated, and this information can be routinely checked as part of the employment audit.

The employment audit may also involve the hiring module 169a screening for other employment application attributes that would disqualify an applicant for employment in a particular position and/or identifying areas where additional investigation is warranted before making a hiring decision, and communicating these findings to the client system 120. Examples of attributes that would disqualify an applicant for employment in a particular position might include, but are not limited to: failure to qualify for security clearance due to criminal history; inability to perform certain physical tasks; unavailability to work a specific shift or extended hours; and lack of qualifications to perform certain functions. Examples of areas where additional investigation is warranted might include, but are not limited to: the withholding of permission to perform a background check, to contact previous employers and personal references, and/or to submit to a drug screen, lie detector, and/or skill evaluation; poor treatment of office staff during the employment application process; mismatch between prior residences and education or employment history; gaps in activities of more than ninety days; and incomplete information on an employment application.

Thus, in the example embodiment of the example method 400 disclosed above, a checklist and a set of form(s) corresponding to an employee termination are generated and sent to a client system in order to facilitate a legally compliant termination of the employee. In addition, information regarding whether the employee is eligible for rehire is stored so that in the event that the terminated employee is ever again considered for employment, this information can be retrieved and factored into the rehire decision.

### 5. Third Example Method of Managing Legally Compliant Termination

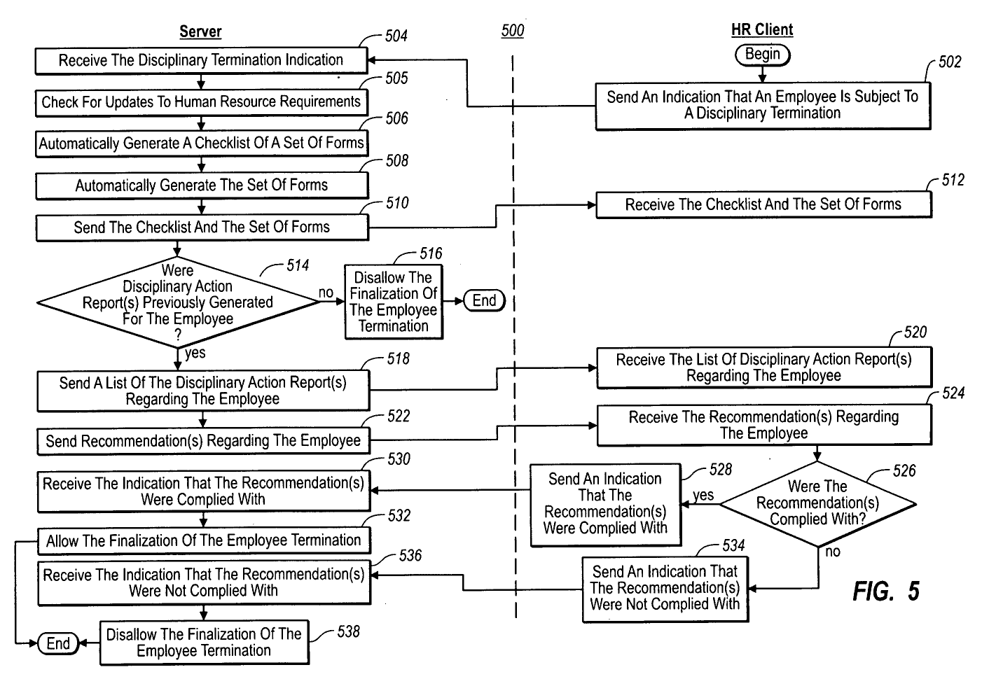

FIG. 5, which will now be described, illustrates a flowchart of a third example method 500 for an employer to use in terminating an employee. The first illustrated act of the example method 500 includes an HR client system sending an indication that an employee is subject to a planned disciplinary termination (act 502). Next, a server system receives the disciplinary termination indication (act 504). Next, the server system automatically checks for human resources requirements updates (act 505). Then, the server system automatically generates a checklist of a set of forms (act 506). Next, the server system automatically generates the set of forms (act 508). Then, the server system sends the checklist and the set of forms (act 510) and the HR client system receives the checklist and the set of forms (act 512). Next, the server system determines whether disciplinary action report(s) were previously generated for the employee (act 514). If the server system determines that disciplinary action report(s) were not previously generated for the employee and received by the server system, then the server system prevents the finalization of the employee termination (act 516).

If, however, the server system determines that disciplinary action report(s) were previously generated for the employee, then the server system sends a list of the disciplinary action report(s) regarding the employee (act 518). Next, the HR client system receives the list of the disciplinary action report(s) regarding the employee (act 520). Then, the server system sends requirement(s) regarding the employee (act 522). Next, the HR client system receives the requirement(s) regarding the employee (act 524). Then, the HR client system determines whether the requirement(s) were complied with (act 526). If the HR client system determines that the requirement(s) were complied with, then the HR client system sends an indication that the requirement(s) were complied with (act 528) and the server system receives the indication that the requirement(s) were complied with (act 530). Next, the server system allows the finalization of the employee termination (act 532).

If, however, the HR client system determines that disciplinary action report(s) were not complied with, then the HR client system sends an indication that the requirement(s) were not complied with (act 534) and the server system receives the indication that the requirement(s) were not complied with (act 536). Consequently, the server system disallows the finalization of the employee termination (act 538). Example embodiments of the example method 500 will also be described with reference to FIG. 1.

In an example embodiment of the method 500, at act 502, one of the client systems 120 can send, and at act 504 the termination module 169d of the server system 110 can receive, an indication that an employee is subject to a planned disciplinary termination. As used herein, the term “disciplinary termination” refers to an employee termination that is initiated by the employer and is based on the employee's poor performance. For example, a planned disciplinary termination can include, but is not limited to, a termination that results from poor performance or other bad behavior of the employee. Acts 502 and 504 can be accomplished, for example, by first selecting the employee from the “Name” dropdown then selecting the “Disciplinary Action” radio button, as disclosed in the example display of FIG. 9.

Continuing with the example embodiment, at act 505, the rules module 162 automatically checks for human resources requirements updates. For example, the rules module 162 may automatically query one or more third party resources 140 to determine the current human resources requirements regarding a planned disciplinary termination of an employee. Thereafter, the rules module 162 can also update any related form(s) with the current human resources requirements.

Continuing with the example embodiment, at act 506, the termination module 169d automatically generates a checklist of a set of form(s) corresponding to the employee termination and, at act 508, the termination module 169d automatically generates the set of form(s) corresponding to the planned disciplinary employee termination. The number, content, and order of the forms listed on the checklist can be automatically adjusted as described above in connection with the method 300. Then, at act 510, the termination module 169d sends, and at act 512 the client system 120 receives, the checklist and the set of form(s) corresponding to the disciplinary employee termination.

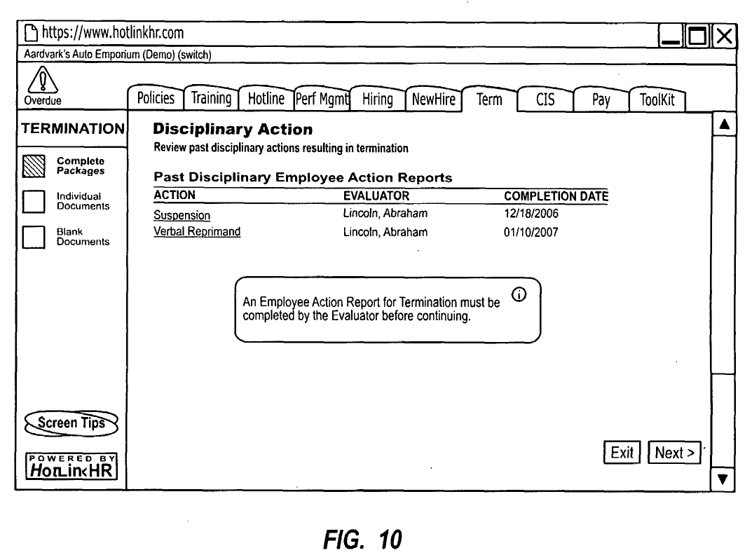

Continuing with the example embodiment, at act 514, the termination module 169d determines whether disciplinary action report(s) were previously generated for the employee that is being terminated. For example, the termination module 169d may communicate with the discipline module 169b to access previously generated disciplinary action reports for the employee being terminated. If the termination module 169d determines that no disciplinary action reports were previously generated for the employee, then, at act 516, the termination module 169d disallows the finalization of the employee termination. In this way, the termination module 169d can ensure that the client complies with legal requirements by forcing the client to generate a disciplinary action report for termination that may be legally necessary prior to the finalization of a disciplinary termination. Act 516 may result, for example, in the notification that reads “An Employee Action Report for Termination must be completed by the Evaluator before continuing” on the example display of FIG. 10. As disclosed in the example display of FIG. 10, disciplinary action reports may be generated for actions such as, but not limited to, suspension, probation, verbal reprimand, and termination. Act 514 may therefore involve the termination module 169d making a determination as to whether a disciplinary action report for particular type of action, such as an employee termination, was previously generated for the employee.

It is understood that at act 514, the termination module 169d may also determine whether any generated disciplinary action report(s) were approved by users having the appropriate authorization level. For example, a disciplinary action report could be generated by a manager but may not be finalized until reviewed and approved by the manager's administrator and/or a designated human resources department employee. Therefore, in at least some embodiments, at act 514 the termination module 169d may ensure that disciplinary action report(s) are not only generated but also approved by user(s) having the appropriate authorization levels to approve such disciplinary action report(s).

More generally, the example disciplinary and termination processes disclosed herein can be performed in parts by various personnel. As but one example, a person such as a first line supervisor may initiate a disciplinary process, while one or more other persons, such as a second line supervisor for example, may perform the portion(s) of such processes that are concerned with the review of the step(s) taken by the first line supervisor. Yet another person may perform the portion(s) of the processes concerned with finalization of the process. Thus, the various portions of the disciplinary and termination processes disclosed herein may be allocated as desired amongst any number and/or type of personnel, depending on factors including, but not limited to, legal requirements and company policies.

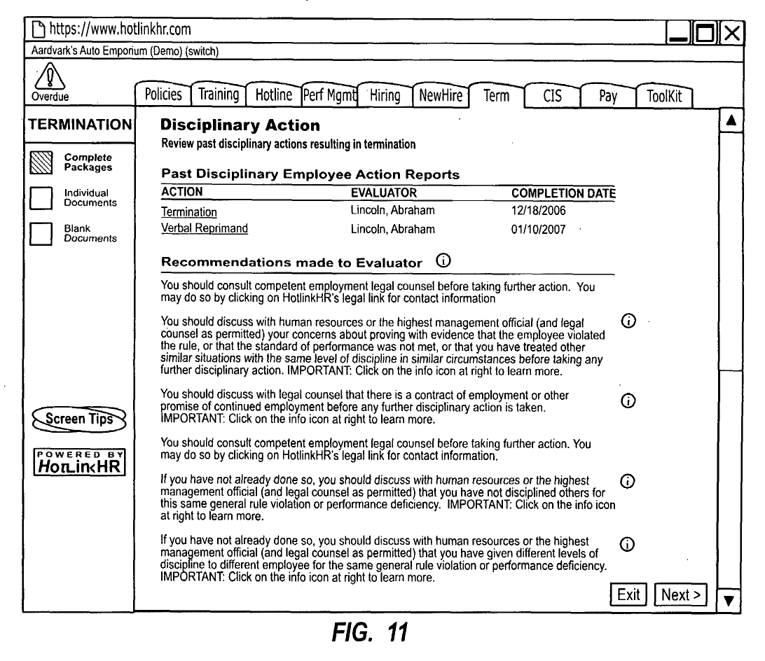

Continuing with the example embodiment, if the termination module 169d determines that legally compliant disciplinary action report(s) were previously generated for the employee, then, at act 518, the termination module 169d sends, and at act 520 the client system 120 receives, the list of the disciplinary action report(s) regarding the employee. Acts 518 and 520 may result, for example, in the display of the disciplinary action reports as disclosed in the example display of FIG. 11. The disciplinary action reports may be displayed by the client system 120 in order to enable the employer to automatically access the employee's history of discipline, and thus evaluate whether finalizing a disciplinary termination is appropriate or legally permissible for the employee.

Continuing with the example embodiment, at act 522, the termination module 169d sends, and at act 524 the client system 120 receives, requirement(s) regarding the employee. These one or more requirements may be automatically generated in response to the generation of a disciplinary action report, for actions such as termination for example, regarding the employee. For example, the termination module 169d may communicate with the discipline module 169b to access a previously generated disciplinary action report for termination regarding the employee being terminated. One or more requirements associated with the disciplinary action report for termination may also be accessed. For example, these requirements may include, but are not limited to, a requirement to consult legal counsel, human resource personnel, or management personnel regarding one or more aspects of the employee's circumstances before completing the termination process for the employee. Additional requirements are listed on the example display of FIG. 11. At act 524, these requirements may then be sent to the client system 120. The client system 120 may then display these requirements, using the example display of FIG. 11 for example, in order enable the employer to automatically access the requirements associated with the employee's previously generated disciplinary action report for termination. These requirements may assist the employer in evaluating whether the finalization of a disciplinary termination is appropriate or legally permissible for the employee.

These requirements that are sent to the client system 120 at act 522 may be generated in response to user answers to questions designed to determine whether further legal or human resource advice may be needed. For example, these questions may include, but are not limited to, the following:
1. Do you feel comfortable after your investigation that you will be able to prove, with evidence, that the employee violated the rule, or the standard of performance was not met, and that you have treated other employees in similar situations with the same level of discipline?
2. Are there any extenuating circumstances that might tend to weigh in favor of not taking disciplinary action?
3. Are there any prior commitments (e.g., written agreements or promises) in employee's personnel file regarding a specific term of employment, continued employment or a requirement of just cause for termination of employment?
4. Is the employee an “at will” employee?
5. Are there any complaints or claims (formal or informal) that the employee has made against the company, any co-worker, customer, contractor, or vendor? (e.g., harassment, discrimination, retaliation, unpaid wages, workers compensation claims, safety issues, labor regulation violations, dishonesty, customer fraud or other claims that the company violated the law in any way, etc.)
6. Has the employee made any whistleblower complaints, whether pursuant to company policy or any applicable whistleblower law/statute?
7. If the employee falls into a “protected category” (e.g., minority, race, religion, color, sex, sexual orientation, national origin, ancestry, citizenship status, uniform service member status, marital status, pregnancy, age/over 40, medical condition—cancer related or HIV/AIDS related, disability, or transgender status), does the employee's “protected category” represent a relatively small portion of your workforce or the employee's work group (e.g. if you have many male sales people and only a few female salespersons)?
8. Is the employee a member of a trade union?
9. Did you impose the same level of discipline that you plan to impose in this situation in any prior, similar situations with other employees?
10. Has the employee taken any leaves of absence within the last year (Medical leave, Family Care leave, Pregnancy leave, Drug/Alcohol Rehabilitation leave, Workers Compensation leave, etc.)?

Requirements to the employer based on the answers to the above questions, and/or other questions, may include, but are not limited to, the following:
1. You should be advised that failing to comply with policies/procedures may result in legal liability to yourself and/or to the company.
2. You should discuss with human resources or the highest management official (and legal counsel as permitted) such matters as the adequacy of evidence, your concerns about proving with evidence that the employee violated the rule, or that the standard of performance was not met, or that you have treated other similar situations with the same level of discipline in similar circumstances before taking any further disciplinary action.
3. You should discuss with human resources or the highest management official (and legal counsel as permitted) any extenuating circumstances that might tend to weigh in favor of not taking disciplinary action.
4. You should discuss with legal counsel whether there is a contract of employment or other promise of continued employment before any further disciplinary action is taken.
5. Before you take further disciplinary action, you should discuss with human resources or the highest management official (and legal counsel as permitted) whether there are complaints or claims (formal or informal) that the employee has made against the company, any co-worker, customer, contractor, or vendor (e.g., harassment, discrimination, retaliation, unpaid wages, workers compensation claims, safety issues, labor regulation violations, dishonesty, customer fraud or other claims that the company or its agents violated the law in any way, etc.).
6. Before you take further disciplinary action, you should discuss with human resources or the highest management official (and legal counsel as permitted) whether the employee has made a whistleblower complaint.
7. Before you take further disciplinary action, you should discuss with human resources or the highest management official (and legal counsel as permitted) whether there may be “protected categories” or “protected status” which cover the employee (e.g., minority race, religion, color, sex, sexual orientation, national origin, ancestry, citizenship status, uniform service member status, marital status, pregnancy, age (e.g., over 40), medical condition (cancer related or HIV/AIDS related), disability, or transgender status).
8. Before you take further disciplinary action, you should discuss with human resources or the highest management official (and legal counsel as permitted) whether there may be prior situations where the same general rule violation occurred or the same performance deficiency existed with other employees where you did not impose the same level of discipline that you plan to impose in this situation.
9. Before you take further disciplinary action, you should discuss with human resources or the highest management official (and legal counsel as permitted) whether the employee is a member of a trade union.
10. Before you take further disciplinary action, you should discuss with human resources or the highest management official (and legal counsel as permitted) that the employee has taken a leave of absence ti within the last year (Medical leave, Family Care leave, Pregnancy leave, Drug/Alcohol Rehabilitation leave, Workers Compensation leave, etc.).

Continuing with the example embodiment, at act 526, the client system 120 determines whether the requirement(s) received at act 524 were complied with. For example, the client system 120 may determine whether an employer has selected a control on a display that affirmatively indicates that the requirement(s) received at act 524 were complied with. If the indication is positive, then, at act 528, the client system 120 sends, and at act 530 the termination module 169d receives, an indication that the requirement(s) were complied with, and at act 532, the termination module 169d allows the finalization of the employee termination. Conversely, if the indication is negative, then, at act 534, the client system 120 sends, and at act 536 the termination module 169d receives, an indication that the requirement(s) were not complied with, and at act 538 the termination module 169d disallows the finalization of the employee termination. In this way, the termination module 169d can ensure compliance with one or more requirements that may be appropriate or legally necessary prior to the finalization of a disciplinary termination.

Thus, in the example embodiment of the example method 500 disclosed above, a checklist and a set of form(s) corresponding to a disciplinary employee termination are generated and sent to a client system in order to facilitate a legally compliant disciplinary termination of the employee. In addition, information regarding whether disciplinary action report(s) have been generated, and whether requirement(s) have been complied with, is gathered in order to ensure that the employee termination is finalized in compliance with legal requirements.

The example embodiments disclosed herein may be embodied in other specific forms. The example embodiments disclosed herein are to be considered in all respects only as illustrative and not restrictive.

What is claimed is:

1. In a client-server environment, a human resources method for employee termination procedures, the method comprising the following acts:
a) a server system receiving, from a client system, an indication that an employee termination is voluntary;
b) the server system automatically generating a checklist listing a set of forms that correspond to the voluntary employee termination;
c) the server system automatically generating the set of forms; and
d) the server system sending, to the client system, the checklist and the set of forms.

2. The method as recited in claim 1, wherein the act a) further comprises the server system receiving, from the client system, information regarding the reason(s) for the voluntary employee termination.

3. The method as recited in claim 1, wherein the act a) further comprises the server system receiving, from the client system, an indication as to whether the employee held a sales position or a non-sales position.

4. The method as recited in claim 1, wherein the act c) further comprises the server system auto-populating a portion of one or more of the forms with available data.

5. The method as recited in claim 1, further comprising the following acts:
a.1) the server system automatically checking for human resources requirements updates; and
a.2) the server system automatically updating any related form(s) with any necessary human resources requirements updates.

6. In a client-server environment, a human resources method for employee termination procedures, the method comprising the following acts:
a) a server system receiving, from a client system, an indication that an employee is subject to a termination and an indication as to whether or not the employee is eligible for rehire;
b) the server system automatically generating a checklist listing a set of forms that correspond to the employee termination;
c) the server system automatically generating the set of forms; and
d) the server system sending, to the client system, the checklist and the set of forms.

7. The method as recited in claim 6, wherein the indication concerning rehire indicates that the employee is eligible for rehire.

8. The method as recited in claim 7, further comprising the following acts:
e) the server system receiving, from the client system, an employment application for the employee;
f) the server system accessing the previously received indication concerning rehire; and
g) the server system sending, to the client system, an indication that the employee is eligible for rehire.

9. The method as recited in claim 8, further comprising the following acts:
h) the server system determining that one or more employment application attributes disqualify the employee for employment in a particular position; and
i) the server system sending, to the client system, an indication of the one or more employment application attributes that disqualify the employee for employment in the particular position.

10. The method as recited in claim 8, further comprising the following acts:
h) the server system determining one or more areas where investigation is recommended before making a hiring decision; and
i) the server system sending, to the client system, a recommendation that the one or more areas be investigated before making a hiring decision.

11. The method as recited in claim 6, wherein the indication concerning rehire indicates that the employee is not eligible for rehire

12. The method as recited in claim 11, further comprising the following acts:
e) the server system receiving, from the client system, an employment application for the employee;
f) the server system accessing the previously received indication concerning rehire; and
g) the server system sending, to the client system, an indication that the employee is not eligible for rehire.

13. The method as recited in claim 6, wherein the act c) further comprises the server system auto-populating a portion of one or more of the forms with available data.

14. The method as recited in claim 6, further comprising the following acts:
a.1) the server system automatically checking for human resources requirements updates; and
a.2) the server system automatically updating any related form(s) with any required human resources requirements updates.

15. In a client-server environment, a human resources method for employee termination procedures, the method comprising the following acts:
a) a server system receiving, from a client system, an indication that a planned employee termination is disciplinary;
b) the server system sending, to the client system, a list of one or more disciplinary action reports that have been previously generated regarding the employee;
c) the server system sending, to the client system, one or more requirements that were previously automatically generated in response to a previous generation of a disciplinary action report for termination regarding the employee;
d) the server system automatically generating a checklist listing a set of forms that correspond to the disciplinary employee termination;
e) the server system automatically generating the set of forms; and
f) the server system sending, to the client system, the checklist and the set of forms.

16. The method as recited in claim 15, further comprising the following acts:
g) the server system receiving, from the client system, an indication that the one or more requirements were complied with; and
h) the server system enabling the finalization of the employee termination.

17. The method as recited in claim 15, further comprising the following acts:
g) the server system receiving, from the client system, an indication that one or more of the requirements were not complied with; and
h) the server system preventing the finalization of the employee termination.

18. The method as recited in claim 15, further comprising the following act:
g) the server system enabling the finalization of the employee termination where a disciplinary action report for termination regarding the employee was previously generated.

19. The method as recited in claim 15, wherein the act e) further comprises the server system auto-populating a portion of one or more of the forms with available data.

20. The method as recited in claim 15, further comprising the following acts:
a.1) the server system automatically checking for human resources requirements updates; and
a.2) the server system automatically updating any related form(s) with any required human resources requirements updates.

21. In a client-server environment, a human resources method for employee termination procedures, the method comprising the following acts:
a) a client system sending, to a server system, an indication that an employee is subject to a termination; and
b) the client system receiving, from the server system, a set of forms that correspond to the employee termination and a checklist listing the set of forms.

22. The method as recited in claim 21, further comprising:
a. 1) the client system sending, to the server system, an indication that the employee is eligible for rehire;
c) the client system sending, to the server system, an employment application for the employee; and
d) the client system receiving, from the server system, an indication that the employee is eligible for rehire.

23. The method as recited in claim 21, further comprising:
a. 1) the client system sending, to the server system, an indication that the employee is not eligible for rehire, and the method further comprises the following acts:
c) the client system sending, to the server system, an employment application for the employee; and
d) the client system receiving, from the server system, an indication that the employee is not eligible for rehire.

24. The method as recited in claim 21, further comprising:
a.1) the client system sending, to the server system, an indication that an employee is subject to a disciplinary termination; and
c) the client system receiving, from the server system, a list of one or more disciplinary action reports that have been previously generated regarding the employee;
d) the client system receiving, from the server system, one or more requirements that were previously automatically generated in response to a previous generation of a disciplinary action report for termination regarding the employee;
e) the client system determining that the one or more requirements have been complied with; and
f) the client system sending, to the server system, an indication that the one or more requirements have been complied with.

25. The method as recited in claim 21, further comprising:
a. 1) the client system sending, to the server system, an indication that an employee is subject to a disciplinary termination; and
c) the client system receiving, from the server system, a list of one or more disciplinary action reports that have been previously generated regarding the employee;
d) the client system receiving, from the server system, one or more requirements that were previously automatically generated in response to a previous generation of a disciplinary action report for termination regarding the employee;
e) the client system determining that the one or more requirements have not been complied with; and
f) the client system sending, to the server system, an indication that the one or more requirements have not been complied with.
